(19) United States
(12) Patent Application Publication
(10) Pub. No.: US 2012/0208008 A1
(43) Pub. Date: Aug. 16, 2012

(54) GRAPHENE-BASED THIN FILMS IN HEAT CIRCUITS AND METHODS OF MAKING THE SAME

(75) Inventors: James M. Tour, Bellaire, TX (US); Vladimir Volman, Newton, PA (US); Yu Zhu, Houston, TX (US)

(73) Assignees: Lockheed Martin Corporation, Moorestown, NJ (US); William Marsh Rice University, Houston, TX (US)

(21) Appl. No.: 13/355,212

(22) Filed: Jan. 20, 2012

Related U.S. Application Data
(60) Provisional application No. 61/434,713, filed on Jan. 20, 2011.

(51) Int. Cl. B32B 9/00; B32B 13/04; B32B 27/40; B32B 17/06; B32B 27/38; B82Y 40/00; B82Y 99/00

(52) U.S. Cl. 428/336; 428/688; 428/426; 428/446; 428/698; 428/702; 428/423.1; 428/473.5; 428/413; 428/500; 427/122; 977/734; 977/742; 977/842

(57) ABSTRACT

In various embodiments, the present invention provides electrically conductive and radio frequency (RF) transparent films that include a graphene layer and a substrate associated with the graphene layer. In some embodiments, the graphene layer has a thickness of less than about 100 nm. In some embodiments, the graphene layer of the film is adhesively associated with the substrate. In more specific embodiments, the graphene layer includes graphene nanoribbons that are in a disordered network. Further embodiments of the present invention pertain to methods of making the aforementioned electrically conductive and RF transparent films. Such methods generally include associating a graphene composition with a substrate to form a graphene layer on a surface of the substrate.

### CROSS-REFERENCE TO RELATED APPLICATIONS

This application claims priority to U.S. Provisional Patent Application No. 61/434,713, filed on Jan. 20, 2011. The entirety of the above-identified provisional application is incorporated herein by reference.

### STATEMENT REGARDING FEDERALLY SPONSORED RESEARCH

This invention was made with government support under the Air Force Office of Scientific Research Grant No. FA9550-09-1-0581 and the Office of Naval Research Grant No. N000014-09-1-1066, both awarded by the U.S. Department of Defense. The government has certain rights in the invention.

### BACKGROUND OF THE INVENTION

Present-day heat circuits have numerous limitations. Such limitations include bulkiness, limited radio frequency (RF) transparency, restricted frequency operation band, high incretion loss, high sensitivity to RF signal polarization, restricted antenna beam scan performance, and high costs. Therefore, a need exists for the development of improved heat circuits that are broadband, compact, thin, affordable, conductive and RF transparent for operating with electromagnetic radiation of any polarization.

### BRIEF SUMMARY OF THE INVENTION

In various embodiments, the present invention provides electrically conductive and radio frequency (RF) transparent films that include a graphene layer (or multilayer) and a substrate associated with the graphene layer. In some embodiments, the graphene layer has a thickness of less than about 100 nm. In other embodiments, the graphene layer is a scattered or disordered network of graphene nanoribbons. In some embodiments, the graphene nanoribbons can be mixed with carbon nanotubes.

In some embodiments, the graphene layer of the film is adhesively associated with the substrate. In some embodiments, the graphene layer is selected from the group consisting of functionalized graphene nanoribbons, pristine graphene nanoribbons, doped graphene nanoribbons, pristine graphene, doped graphene, graphene oxide, reduced graphene oxide, chemically converted graphene, split carbon nanotubes, mixtures of graphene nanoribbons and carbon nanotubes, and combinations thereof. In more specific embodiments, the graphene layer includes graphene nanoribbons that are in contiguous sheets.

In some embodiments, the substrate is selected from the group consisting of glass, quartz, boron nitride, alumina, silicon, plastics, polymers, and combinations thereof. In further embodiments, the substrate also includes an adhesive layer that is positioned between the substrate and the graphene nanoribbon layer. In some embodiments, the adhesive layer is selected from the group consisting of polyurethanes, epoxy resins, polyimides, nylons, polyesters, and combinations thereof.

Further embodiments of the present invention pertain to methods of making the aforementioned electrically conductive and RF transparent films. Such methods generally include associating a graphene composition with a substrate to form a graphene layer on a surface of the substrate. In some embodiments, the associating occurs by chemical vapor deposition, mechanical transfer, or spraying of the graphene composition onto the substrate or onto the adhesion layer. In some embodiments, the associating also includes an annealing step that adhesively associates the graphene layer with the substrate. Additional embodiments of the present invention pertain to heat circuits that contain the films of the present invention.

In some embodiments, the films of the present invention have RF transparency between about 0.1 GHz and about 40 GHz. In more specific embodiments, the films of the present invention have RF transparency between about 0.1 GHz and about 18 GHz. In some embodiments, RF transparency means that more than 80%-90% of incident on the film RF power goes through for electromagnetic waves of any polarization, including linear, right hand circular, left hand circular, or elliptical.

The methods and compositions of the present invention provide numerous applications and advantages. In some embodiments, the present invention provides thin and affordable heat circuits that are low in weight, highly conductive, and transparent. In various embodiments, the films of the present invention may be used as coatings for de-icing or anti-icing applications, including the de-icing of antennas, radomes, or aircraft structures such as wing edges.

### BRIEF DESCRIPTION OF THE FIGURES

FIG. 1 illustrates various properties of graphene nanoribbon (GNR) films of the present invention. FIG. 1A is a photograph of a transparent GNR film on glass above a Rice University logo to demonstrate its optical transparency. FIG. 1B shows the relationship between GNR film thickness and sheet resistance measured by radio frequency (RF). FIG. 1C is a photograph showing samples of GNR films coated on polyimide with a polyurethane adhesive layer between the two. FIG. 1D shows the relationship between GNR film thickness and sheet resistance, as measured by an electrical 4-point probe. FIG. 1E is a scanning electron microscope (SEM) image of a disordered or scattered graphene nanoribbon network that was applied by spray coating to a surface. In some embodiments, such films can be used as RF transparent de-icing heat circuits.

FIG. 2 shows a GNR film (of length l) with electrical contacts (area A) on both ends.

FIG. 3 provides information regarding a waveguide transmission test on a GNR film. FIG. 3A shows the results of the waveguide transmission test and a high frequency structural simulator (HFSS) simulation comparison. FIG. 3B shows the setup for the waveguide transmission test.

FIG. 4 shows a waveguide setup. FIG. 4A is a scheme showing a substrate surface with a GNR layer with electrodes that are connected to an electrical power source for heating the GNR layer. FIG. 4B is a photograph of an RG-48 waveguide with a wired GNR film. The GNR film is atop a polyurethane adhesion layer which is further atop a polyimide film. Copper conductive electrodes are on each end of the film. A thermal sensor (thermocouple) in FIG. 4B is under the white tape patch covering the sensor. The thermal sensor monitors the film surface temperature. In combination with volt and current meters (not shown in FIG. 4B), the thermal sensor also allows the detection of variations of graphene film resistance over temperature ranges.

FIG. 5 shows data relating to the resistance of GNR films as a function of temperature. FIG. 5A shows percentage of resistance change of GNR films at different temperatures relative to 20° C. FIG. 5B is taken from the literature to show the effects of temperature on resistance if metals are used instead of a GNR film. The referenced metals are copper (blue), aluminum (red), and silver (purple).

FIG. 6 shows real-time wave guide test results. FIG. 6A shows real-time waveguide test results of GNR films with thicknesses of 110 nm. FIG. 6B shows real-time waveguide test results of GNR films with thicknesses of 75 nm. The legend on the right is the surface temperature of graphene layer.

FIG. 7 illustrates an HFSS infinite graphene sheet model.

FIG. 8 shows return loss of graphene sheets over frequency, azimuth and elevation incident angles (phi and theta) in TE00-mode. FIG. 8A shows the return loss vs. frequency and theta for azimuth angle phi=0 degree. FIG. 8B shows the return loss vs. frequency and theta for azimuth angle phi=30 degrees. FIG. 8C shows the return loss vs. frequency and theta for azimuth angle phi=60 degree. FIG. 8D shows the return loss vs. frequency and theta for azimuth angle phi=90 degrees.

FIG. 9 shows return loss of graphene sheets over frequency, azimuth and elevation incident angles (phi and theta) in TM00-mode. FIG. 9A shows the return loss vs. frequency and theta for azimuth angle phi=0 degree. FIG. 9B shows the return loss vs. frequency and theta for azimuth angle phi=30 degrees. FIG. 9C shows the return loss vs. frequency and theta for azimuth angle phi=60 degree. FIG. 9D shows the return loss vs. frequency and theta for azimuth angle phi=90 degrees.

FIG. 10 shows transmission loss of graphene sheets over frequency, azimuth and elevation incident angles (phi and theta) in TE00-mode. FIG. 10A shows the transmission loss vs. frequency and theta for azimuth angle phi=0 degree. FIG. 10B shows the transmission loss vs. frequency and theta for azimuth angle phi=30 degrees. FIG. 10C shows the transmission loss vs. frequency and theta for azimuth angle phi=60 degree. FIG. 10D shows the transmission loss vs. frequency and theta for azimuth angle phi=90 degrees.

FIG. 11 shows transmission loss of graphene sheets over frequency, azimuth and elevation incident angles (phi and theta) in TM00-mode. FIG. 11A shows the transmission loss vs. frequency and theta for azimuth angle phi=0 degree. FIG. 11B shows the transmission loss vs. frequency and theta for azimuth angle phi=30 degrees. FIG. 11C shows the transmission loss vs. frequency and theta for azimuth angle phi=60 degree. FIG. 11D shows the transmission loss vs. frequency and theta for azimuth angle phi=90 degrees.

### DETAILED DESCRIPTION OF EXEMPLARY EMBODIMENTS

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes only and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Present-day materials that are being used as heat circuits have numerous limitations. Such limitations include bulkiness, limited radio frequency (RF) transparency, highly restricted frequency operation band, high incretion loss, high sensitivity to RF signal polarization, restrictive antenna beam scan performance, and high costs. For instance, conventional radome de-icing circuit designs are based on the usage of copper, nichrome, or other high conductive wires that are printed on dielectric substrates and placed on the top of phased array apertures or radomes. The main disadvantage of this approach is that the de-icing circuitry can cause a deleterious polarization of the fields radiated by the radar phased array. The de-icing circuitry can also affect the array steering angle. In order to reduce this sensitivity, multilayer sandwiches containing meander de-icing circuits are used. However, such kinds of circuits are bulky, heavy, costly, and limited in RF transparency.

Therefore, a need exists for the development of improved heat circuits that are compact, thin, affordable, more conductive and RF transparent. The present invention addresses this need by providing novel films that can be used in heat circuits and methods of making them.

Films

In some embodiments, the present invention provides electrically conductive and RF transparent films that include a graphene layer (or multilayer) and a substrate associated with the graphene layer. In some embodiments, the graphene layer is positioned on a top surface of the substrate. In some embodiments, the graphene layer is adhesively associated with the substrate. As set forth in more detail below, various graphene layers and substrates may be utilized in the films of the present invention.

Graphene Layers

The films of the present invention may include various graphene layers or multilayers (i.e., multiple layers of graphene). Non-limiting examples of suitable graphene layers include graphene nanoribbons (GNR), including functionalized graphene nanoribbons, pristine graphene nanoribbons, doped graphene nanoribbons, and combinations thereof. In more specific embodiments, the graphene layers may include graphene oxide nanoribbons, reduced graphene oxide nanoribbons (also referred to as chemically converted graphene nanoribbons), and combinations thereof. In further embodiments, the graphene layers can be derived from exfoliated graphite, graphene nanoflakes, or split carbon nanotubes.

The graphene layers of the present invention may also include one or more layers of graphene. Such graphenes may include, without limitation, pristine graphene, doped graphene, graphene oxide, reduced graphene oxide, chemically converted graphene, functionalized graphene and combinations thereof. In some embodiments, the graphene may be functionalized by organic addends, such as aryl groups, phenol groups, alkyl groups, vinyl polymers and the like.

In further embodiments, the graphene layers of the present invention may include split carbon nanotubes. In various embodiments, the split carbon nanotubes may be derived from single-walled carbon nanotubes, multi-walled carbon nanotubes, double-walled carbon nanotubes, ultrashort carbon nanotubes, pristine carbon nanotubes, functionalized carbon nanotubes, and combinations thereof. In additional embodiments, the graphene layers of the present invention may include mixtures of graphene nanoribbons and carbon nanotubes.

In various embodiments, the graphene layers of the present invention may be associated with one or more surfactants or polymers. In further embodiments, the graphene layers may be doped with various additives. In some embodiments, the additives may be one or more heteroatoms of B, N, O, Al, Au, P, Si or S. In more specific embodiments, the doped additives may include, without limitation, melamine, carboranes, aminoboranes, phosphines, aluminum hydroxides, silanes, polysilanes, polysiloxanes, sulfides, thiols, and combinations thereof. In more specific embodiments, the graphene layers may be HNO₃ doped and/or AuCl₃ doped.

In some embodiments, the graphene layer may cover an entire surface area of a substrate in a uniform manner. In additional embodiments, the graphene layer may be scattered throughout a surface area of a substrate in a non-uniform manner. In various embodiments, this could include spray-on random networks of graphene nanoribbons or substantially aligned graphene nanoribbons.

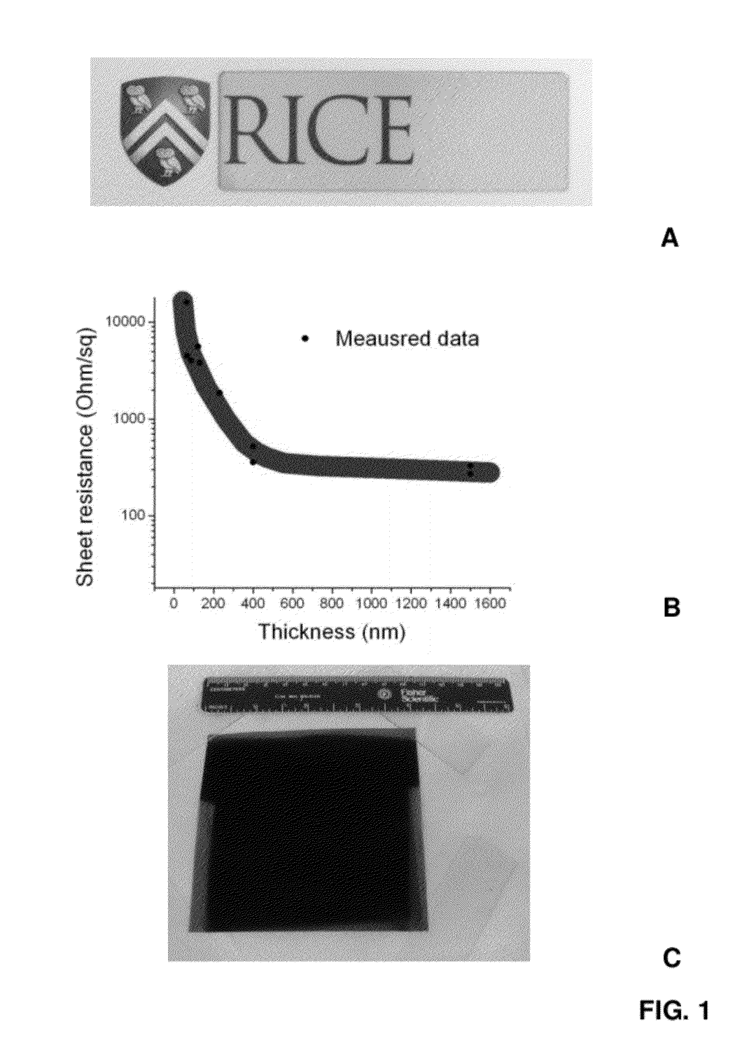

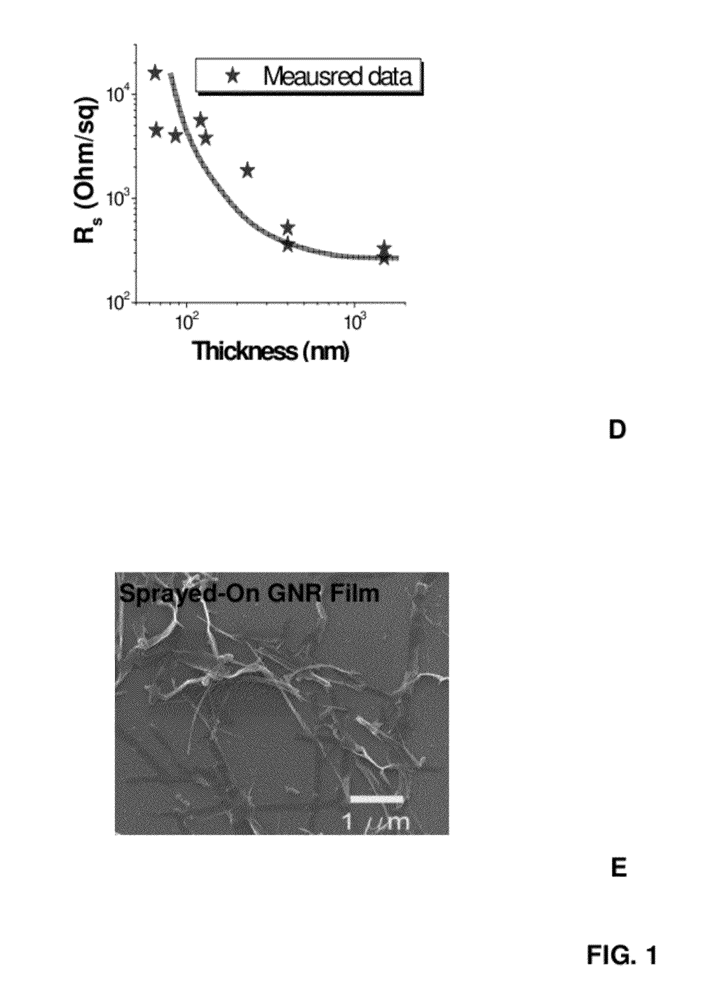

In some embodiments, substantially aligned graphene nanoribbons can be attained by shear forces. In other embodiments, substantially aligned graphene nanoribbons can be attained by magnetic alignment of graphene nanoribbons that contain a paramagnetic material, such as iron oxide. In more specific embodiments, the graphene layers of the present invention may include graphene nanoribbons that are arranged on a substrate as contiguous sheets. In other embodiments, the graphene layers of the present invention may include graphene nanoribbons that are scattered on a substrate in a random manner. See, e.g., FIG. 1E. In further embodiments, the graphene layers of the present invention may include spray-on graphenes, including graphene sheets and graphenes that are not in sheet form.

The graphene layers of the present invention may also have various thicknesses. In some embodiments, the graphene layers of the present invention have thicknesses that range from about 75 nm to about 100 nm (e.g., 110 nm). In some embodiments, the graphene layers have thicknesses of less than about 100 nm. In some embodiments, the graphene layers have thicknesses that range from about 10 nm to about 50 nm.

In addition, the graphene layers of the present invention may have numerous layers. In some embodiments, graphene layers of the present invention may consist of only one layer (i.e., a monolayer). In other embodiments, the graphene layers of the present invention may consist of multiple layers (e.g., 2-9 layers or more).

Substrate

Various substrates may be utilized in the films of the present invention. Non-limiting examples of substrates include glass, quartz, boron nitride, alumina, silicon, plastics, polymers, and combinations thereof. More specific examples of suitable substrates include ceramics, polyimides, polytetrafluoroethylenes, polyethylene terephthalate (PET) and other polymer films that have melting temperatures over 150° C.

Desirably, the substrates of the present invention are also RF transparent in order to maintain the transparency of the films. For instance, in a specific embodiment, the substrate is glass. In another specific embodiment, the substrate is PET. In another embodiment, the substrate is polyimide.

The substrates of the present invention can also have various shapes and properties. For instance, in some embodiments, the substrate has a non-planar shape such as dome-shaped. In additional embodiments, the substrate has a planar shape. In further embodiments, the substrate is flexible at room temperature. In additional embodiments, the substrate is rigid at room temperature.

In some embodiments, the substrate may also include an adhesive layer. In some embodiments, the adhesive layer may be coated onto a surface of the substrate. In some embodiments, the adhesive layer may be positioned between the substrate and the graphene layer. Non-limiting examples of adhesive layers include polyurethanes, epoxy resins, polyimides, nylons, polyesters, and combinations thereof.

Methods of Making Films

Further embodiments of the present invention pertain to methods of making the aforementioned electrically conductive and RF transparent films. Such methods generally include associating a graphene composition with a substrate to form a graphene layer on a surface of the substrate. Such methods may also include a subsequent annealing step.

Associating Graphene Compositions with Substrates

Graphene compositions that may be associated with substrates may include, without limitation, graphene nanoribbons, graphenes, split carbon nanotubes, and combinations thereof (as previously described). In addition, the graphene compositions may be associated with substrates by various methods. Such methods may include, without limitation, chemical vapor deposition, spraying, sputtering, spin coating, blade coating, rod coating, film coating, printing, painting, mechanical transfer, and combinations of such methods. In more specific embodiments, the association might include mechanical placement of the graphene composition, including roll-to-surface or roll-to-roll placement of the graphene composition, or by spray-on or paint-on application of the graphene composition.

In further embodiments, graphene compositions may be associated with the substrate by first splitting carbon nanotubes and then sputtering the split carbon nanotubes onto the substrate. Various methods may be used to split carbon nanotubes. In some embodiments, carbon nanotubes may be split by potassium or sodium metal. In some embodiments, the split carbon nanotubes may then be functionalized by various functional groups, such as alkyl groups. Additional variations of such embodiments are described in U.S. Provisional Application No. 61/534,553 entitled “One Pot Synthesis of Functionalized Graphene Nanoribbon and Polymer/Graphene Nanoribbon Nanocomposites.” Also see Higginbotham et al., “Low-Defect Graphene Oxide Nanoribbons from Multiwalled Carbon Nanotubes,” ACS Nano 2010, 4, 2059-2069. Also see Applicants' co-pending U.S. patent application Ser. No. 12/544,057 entitled “Methods for Preparation of Graphene Nanoribbons From Carbon Nanotubes and Compositions, Thin Films and Devices Derived Therefrom.” Also see Kosynkin et al., “Highly Conductive Graphene Nanoribbons by Longitudinal Splitting of Carbon Nanotubes Using Potassium Vapor,” ACS Nano 2011, 5, 968-974.

In various embodiments, the graphene compositions of the present invention may be dissolved or suspended in one or more solvents. Examples of suitable solvents include, without limitation, dichlorobenzene, ortho-dichlorobenzene, chlorobenzene, chlorosulfonic acid, dimethyl formamide, N-methylpyrrolidone, water, alcohol and combinations thereof.

In further embodiments, the graphene compositions of the present invention may also be associated with a surfactant. Suitable surfactants include, without limitation, sodium dodecyl sulfate (SDS), sodium dodecylbenzene sulfonate, Triton X-100, and the like.

In some embodiments, the associating step may also be followed by a reduction step to convert an oxidized graphene layer to a reduced graphene layer. In some embodiments, the reduction step can include, without limitation, treatment with heat or treatment with a reducing agent (e.g., hydrazine, sodium borohydride, and the like). In various embodiments, heat treatment may occur in an atmosphere that is under a stream of one or more gases, such as N₂, Ar, H₂ and combinations thereof.

Annealing

Various embodiments of the present invention also include an annealing step in order to adhesively associate a graphene layer with a substrate. In some embodiments, the annealing step includes a heat treatment of the electrically conductive and RF transparent film at various temperature ranges. Such temperature ranges may include temperatures between about 100° C. and 250° C. In more specific embodiments, the annealing temperature may be about 200° C. In some embodiments, the heat treatment occurs in the absence of oxygen. In more specific embodiments, the heat treatment occurs in an inert environment, such as an H₂/Ar purged furnace.

Furthermore, the thicknesses of the formed graphene layers may be controlled by adjusting various parameters. Such parameters include, without limitation, graphene composition volume, graphene composition concentration, and the amount of graphene composition solution applied onto the substrate. Additional parameters that can control graphene film thickness include spraying parameters (e.g., spraying speed and sample-sprayer distance).

In more specific and non-limiting embodiments, the RF transparent and electrically conductive film includes a graphene nanoribbon layer that is adhesively associated to a glass substrate through a polyurethane adhesive layer. Such films may be made by dispersing graphene nanoribbons in ortho-dichlorobenzene to a final concentration of 1 mg/mL and spraying the solution onto a glass substrate that was pre-coated with polyurethane and pre-heated to about 200° C. In cases where graphene oxide nanoribbons are used as the graphene composition, the films may also be reduced chemically or thermally in order to achieve higher conductivity.

Film Properties

The films of the present invention provide numerous advantageous properties. Such properties include, without limitation, transparency, high conductivity, compactness, low resistance, affordability, uniform coverage of large surfaces, and durability.

RF Transparency

Since the thicknesses of the films of the present invention are generally in the range of nanometers, the films can be practically transparent to lights of a preferred wavelength, or to RF electromagnetic waves of any polarization in wide frequency ranges. In some embodiments, the films of the present invention have a transparency of more than about 70% in a wavelength region between about 400 nm and about 1200 nm. In more specific embodiments, the films of the present invention have transparencies of more than about 79% in the same wavelength region.

In some embodiments, the films of the present invention may be RF transparent regardless of the polarization. RF transparent films generally refer to films that have low absorbance of RF radiation. In some embodiments, the RF transparent films may have transparencies low enough to keep the RF source from being greater than 50% retarded by the film over a range of polarization. In further embodiments, RF transparency means that more than 80%-90% of incident on the film RF power goes through for electromagnetic waves of any polarization, including linear, right hand circular, left hand circular, or elliptical.

In some embodiments, RF transparent films of the present invention absorb less than 10% of RF radiation. In some embodiments, RF transparent films of the present invention absorb less than 5% of RF radiation. In more specific embodiments, RF transparent films of the present invention absorb less than 1% of RF radiation.

The films of the present invention may also have RF transparencies at different frequencies. For instance, in some embodiments, the films of the present invention have RF transparencies between about 0.1 GHz and about 40 GHz. In more specific embodiments, the films of the present invention have RF transparencies between about 0.1 GHz and about 18 GHz.

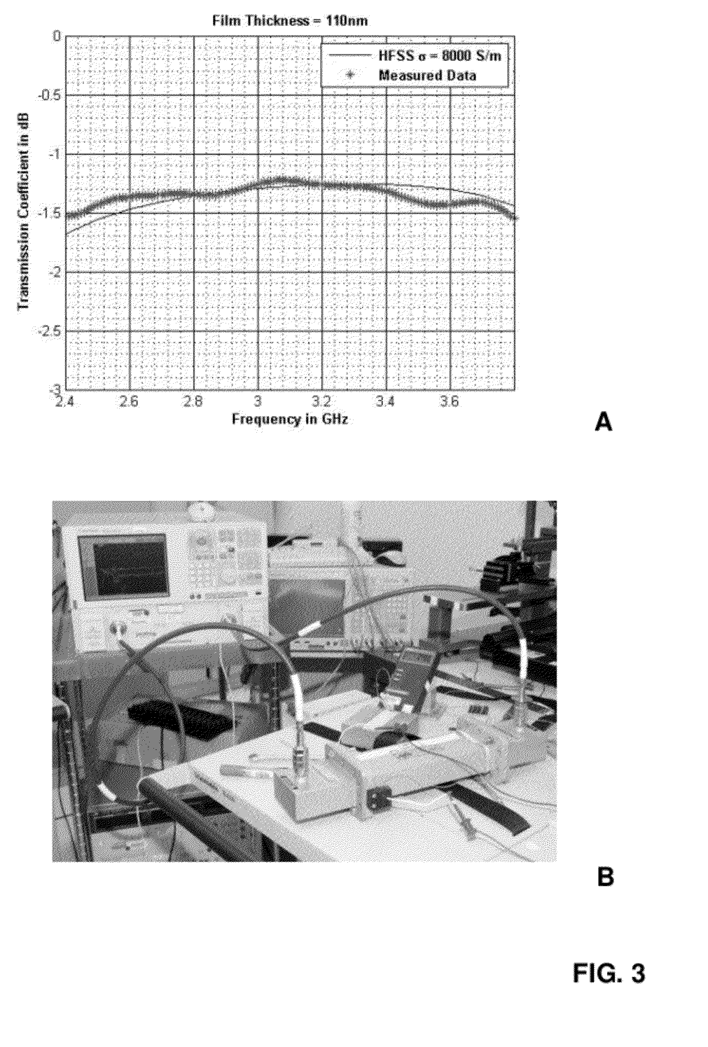

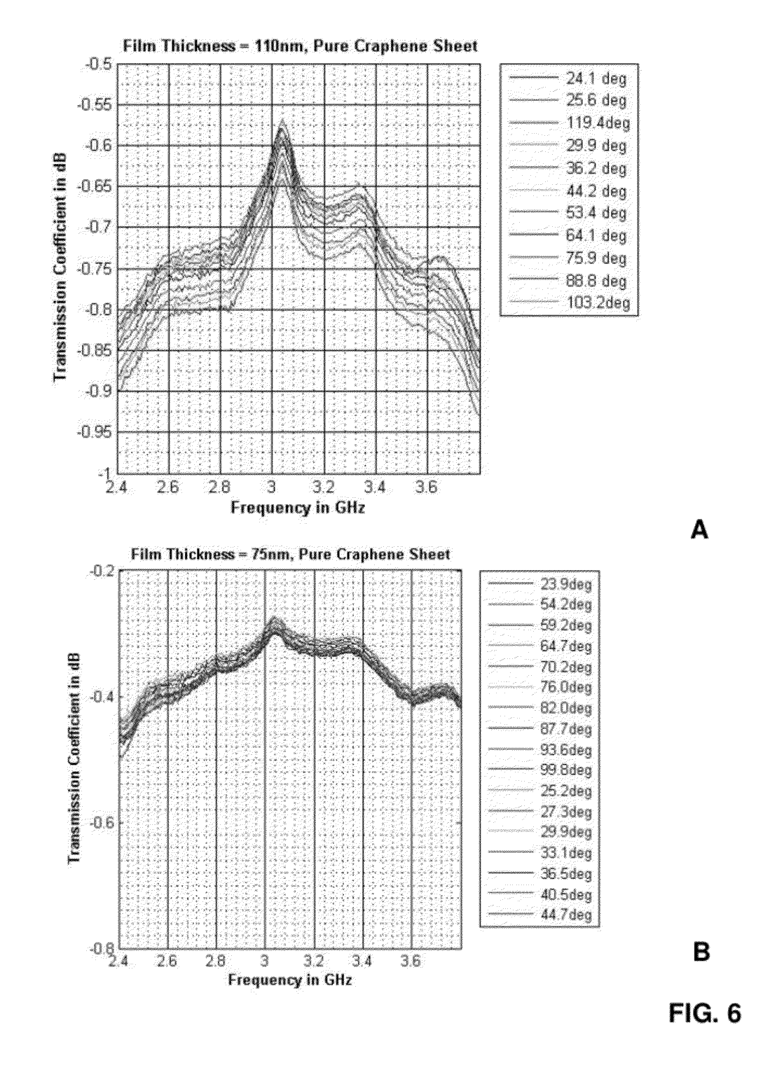

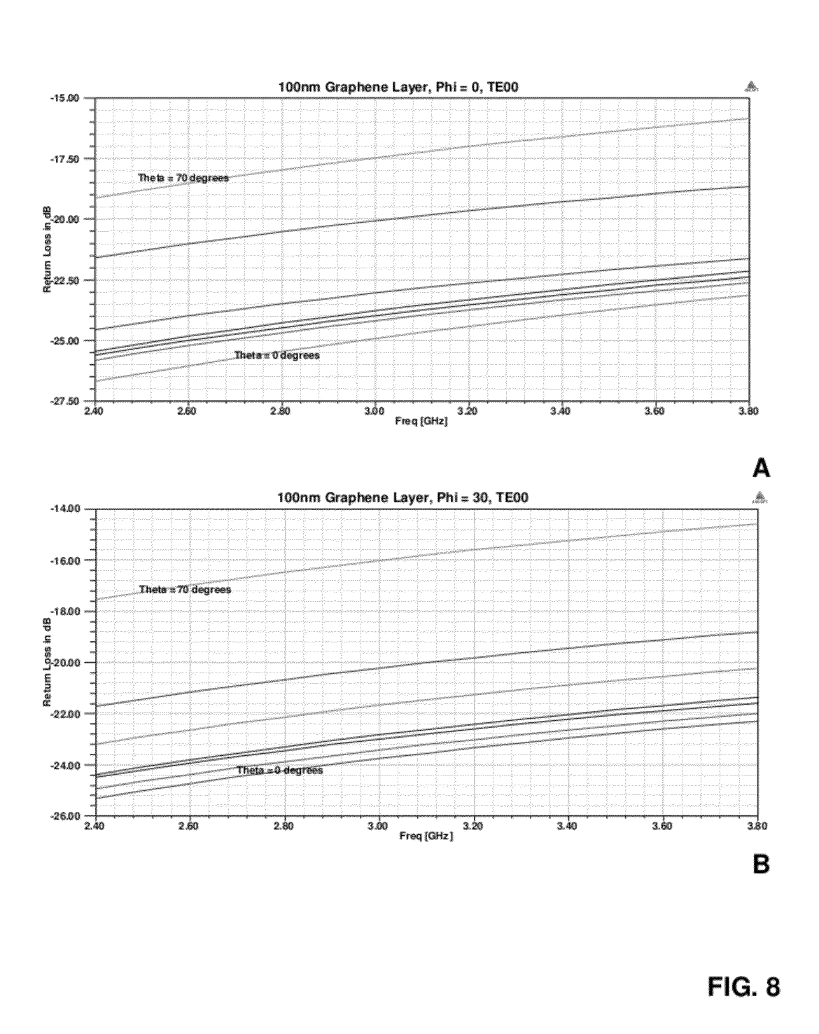

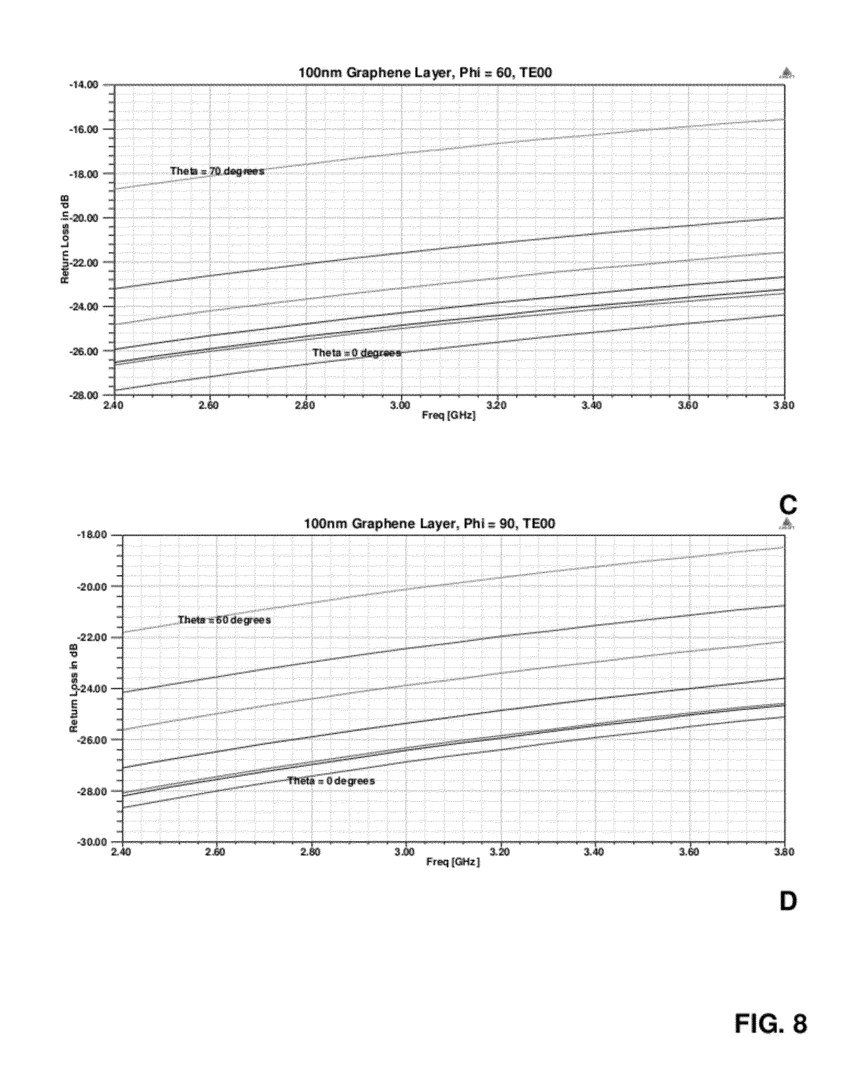

Theoretical and numerical analyses have shown that the graphene nanoribbon films of the present invention with thicknesses of less than 100 nm and conductivities of 20-70 S/cm for direct current (DC) have return and scan losses that are almost independent of frequency, polarization and scan angle. According to this data, the graphene nanoribbon films provide a match better than −20 dB and a scan loss not more than −0.4 dB at elevation angles up to 60 degrees in octave bandwidths. Since the scan losses are slightly different for TM and TE-modes, some level of depolarization is expected for high elevation scan angles. In the worst case of 75°, this difference does not exceed 0.7 dB, which is much less than for any known conventional heat circuit. The measured RF loss in dB vs. frequency and graphene nanoribbon film parameters are presented in FIG. 3A (measured and predicted by HFSS simulation), FIG. 6 (measured data) and FIGS. 8-11 (predicted by HFSS simulation).

High Conductivity

The films of the present invention are also electrically conductive. For instance, the conductivity of graphene nanoribbon films can range from about 1 S/cm to about 300 S/cm, or between about 20-70 S/cm for direct current (DC).

Compactness

The films of the present invention are also very thin and lightweight. For instance, as set forth previously, the thickness of various films of the present invention may be less than about 100 nm. Likewise, the weight of the films of the present invention may be in the milligram or gram range. For instance, a film on a 100 m² surface may only weigh about 10 g. Such low weights and thicknesses are much less than the present de-icing coating layers used in radomes.

Low Resistance

The films of the present invention can also have low resistance. For instance, the sheet resistance of the films of the present invention can be as low as described in FIGS. 1B and 1D. The resistance of the films can also vary with thickness. For instance, in some embodiments, the resistance of the films can be 10,000 ohm/sq at 100 nm film thickness to 150 ohm/sq at 1,000 nm film thickness.

Affordability

The films of the present invention also provide coatings that are low in cost. For instance, the graphene compositions and substrates of the present invention can be produced in multi-gram scale quantities from readily available and affordable raw materials.

Uniform Coverage of Large Surfaces

The films of the present invention can also be produced in mass quantities with large surface areas. For instance, by utilizing spray coating techniques, Applicants have produced 3-inch sized films. See, e.g., FIG. 1C. Larger films can also be produced by similar methodologies (e.g., 0.1 m×0.1 m films and 10 m×10 m films).

Durability

The methods of the present invention also provide films that are durable. For instance, the graphene portions of the films of the present invention can have melting points over 2000° C. in inert atmospheres. The overall components (i.e., graphene film, adhesion layer and substrate) of the present invention can also be stable at various environmental temperatures (e.g., −100° C. to 200° C.). Furthermore, the films of the present invention can be resistant to oxidation by various environmental factors, such as atmospheric oxygen. In addition, when adhesive layers such as polyurethanes are utilized, the graphene layers of the present invention can remain associated with a substrate for long periods of time and under various environmental conditions. Therefore, the films of the present invention can tolerate hostile environments, including salt water, strong winds, snow, ice, gun blasts, dust, and wide temperature variations (e.g., −30° C. to +150° C.).

Applications

The methods and compositions of the present invention provide numerous applications. For instance, in some embodiments, the films of the present invention may be used as components of heat circuits, such as anti-icing or de-icing circuits. Thus, in some embodiments, the present invention pertains to heat circuits that contain one or more films of the present invention.

In some embodiments, the films of the present invention may be utilized in radomes. In some embodiments, the films of the present invention may be used as part of de-icing or anti-icing circuits of an antenna, such as a phased array antenna, ground radars, UAV antennas, and the like. In further embodiments, the films of the present invention can be used as de-icing or anti-icing circuits in ships, aircraft, spacecraft, boats, bridges, and other structures.

Additional applications can also be envisioned. For instance, the films of the present invention may be used as components of aircraft and helicopter composites to provide heating for de-icing.

### Additional Embodiments

Reference will now be made to more specific embodiments of the present disclosure and experimental results that provide support for such embodiments. However, Applicants note that the disclosure below is for exemplary purposes only and is not intended to limit the scope of the claimed invention in any way.

The Examples below pertain to making and utilizing graphene nanoribbon thin films that are conductive and transparent to radio frequency waves. The Examples below also pertain to the use of such thin films as de-icing systems.

Icing protection systems include anti-icing systems (i.e., prevent ice from accumulating) and de-icing systems (i.e., remove ice after accumulation). De-icing and anti-icing systems are usually open to hostile environments, such as high winds with sand particles, droplets of water, hail, salt water exposure, wide temperature variations, gun blasts, and the like. Thus, de-icing and anti-icing systems must demonstrate durability and good adhesiveness to the heated surface. Furthermore, de-icing and anti-icing systems must be lightweight and affordable. Moreover, the systems must have the ability to cover large surface areas. In cases where anti-icing and de-icing systems are used to cover antennas or radomes, the de-icing film must be transparent to radio frequency (RF) signals of any polarization with minimal impact on antenna scan performance.

Here, Applicants disclose a new type of antenna or radome coating based on conductive graphene nanoribbon (GNR) thin films. In a standard setup, a thin GNR thin film is placed on the top of a surface and used to conduct DC or AC current without significantly attenuating RF signals. The resistance of the GNR film changes little throughout the temperature range of the experiment (−20 to 100° C.). Therefore, there would be minimal effective change in the RF output through the structure over that temperature range. Thus, the resistance of the GNR film meets the required value to generate sufficient heat for de-icing the protected surface under conventional AC voltage. Furthermore, the GNR film is thin enough for RF signal transmittance. Thus, ice formation on the protective surface of the GNR film can be prevented without affecting the operation of antenna arrays.

### Example 1

### Fabrication of GNR Films

A typical fabrication procedure for a GNR film involves the steps described herein. First, a glass surface was cleaned with acetone and deionized water. Next, polyurethane (a type used a clear-coat automotive paint) was spin-coated on the glass surface. Typical spin times were about 60 seconds at around 4,000 rpm. The sample was then left at room temperature for 12 hours until the film was solidified. Next, the glass substrate with the polyurethane coating was placed on a hot plate at 200° C. A pre-made solution of GNRs dissolved in ortho-dichlorobenzene to a concentration of about 1 mg/mL was then sprayed onto the surface of the glass using an airbrush. The sample was then washed with ethanol to remove the residual solvent. In other embodiments, a polyimide film was used as a substrate. Photographs of the fabricated GNR films are shown in FIGS. 1A and 1C. The relationship between sheet resistance and GNR film thickness was also studied. See FIGS. 1B and 1D.

The GNRs utilized in the above fabrication were synthesized by splitting multiwall carbon nanotubes with potassium vapor, as previously described. See ACS Nano 2011, 5, (2), 968-74. Such GNRs have high aspect ratios with 3 to 8 graphene layers. The width of the GNRs is between 100 nm and 500 nm. The length of the GNRs is over 5 μm. Without being bound by theory, Applicants envision that such GNRs are promising materials for thin films because they are free of surface oxygen containing groups. Furthermore, the GNRs are highly conductive when compared to other graphene materials. For instance, five layer-thick GNRs exhibit conductivities of 80,000 S/m.

### Example 2

### Modeling RF Transmission Through GNR Films

The straightforward way to evaluate RF transmission through a thin conductive layer is based on a skin depth concept. The theory shows that an electromagnetic wave propagating inside the conductive material reduces in magnitude by factor 1/e in a distance Δ(skin depth in meters), in accordance with the following formula:

Δ=503/\sqrt{fμσ} (1),

where f is the frequency in Hz, μ is the relative magnetic permeability of conductive material, and σ is the bulk electrical conductance in S/m.

Since antenna and radome de-icing is considered as an application of this work, it is convenient to use frequencies in the GHz range. The isotropic GNR film is not magnetic. Thus, μ=1. At the GHz frequency range, the skin depth can be calculated by the following formula where m is meter:

$$Δ = \frac{0.016}{\sqrt{f σ}} [ m ] \qquad ( 2 )$$

The electrical field strength decreases exponentially at the distance d, in accordance with the following equation L:

$$E ∼ {e}^{- \frac{d}{Δ}} = {e}^{- 63 d \sqrt{f σ}} \qquad ( 3 )$$

Based on this equation, the electrical field strength can be very small if an ultra-thin conductive film (d<<Δ) will meet the requirements of heating. Under this condition, the RF loss of GNT film becomes negligible during de-icing.

### Example 3

### Properties of GNR Films

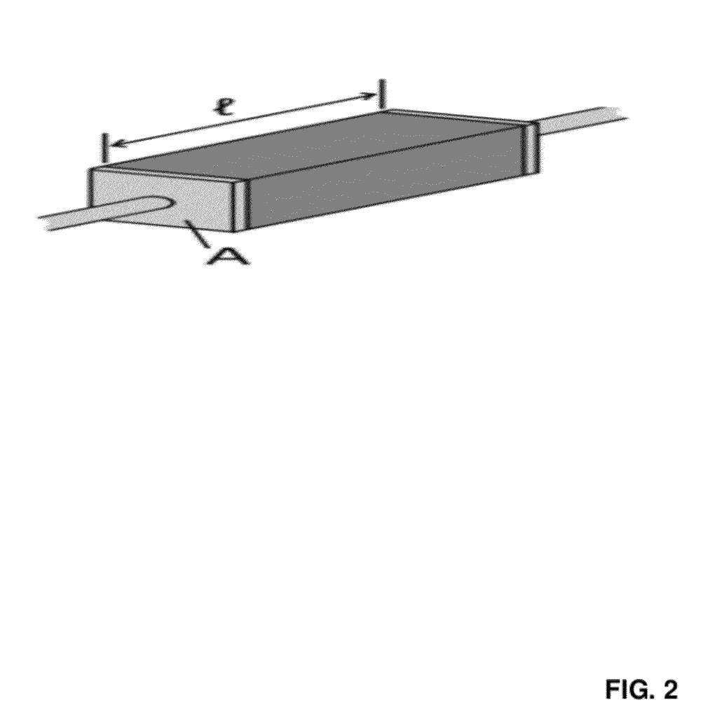

The conductivity and resistance of GNR films on polyimide substrates were studied. In these experiments, the GNR films were placed between copper electrodes, as illustrated in FIG. 2. Table 1 provides a summary of the obtained data.

TABLE 1
Properties of GNR films on polyimide substrates
with a polyurethane adhesion layer.

| | Resistance at | | | | Graphene | |
|---|---|---|---|---|---|---|
| | Ambient | DC Effective | | Graphene | Layer | Solution |
| | Temperature | Conductivity | Skin Depth | Active Area | Thickness | sprayed |
| | (KΩ) | (KS/m) | Δ (nm) | (inches) | (nm) | (mL) |
| 1 | 2.51 | 7.24 | ~1.1 × 10⁵ | 1 × 2 | ~110 | 7.5 |
| 2 | 9.94 | 2.68 | ~2 × 10⁵ | 1 × 2 | ~75 | 5 |

The DC effective conductivity of the GNR films was calculated through the measured resistance as

$$σ = \frac{l}{A * R} = \frac{2 * {10}^{9}}{Rt} [ \frac{S}{m} ] , \qquad ( 4 )$$

where A=w*t, w is the graphene layer width of 1 inch, t is graphene layer thickness, and l is the graphene layer length of 2 inch.

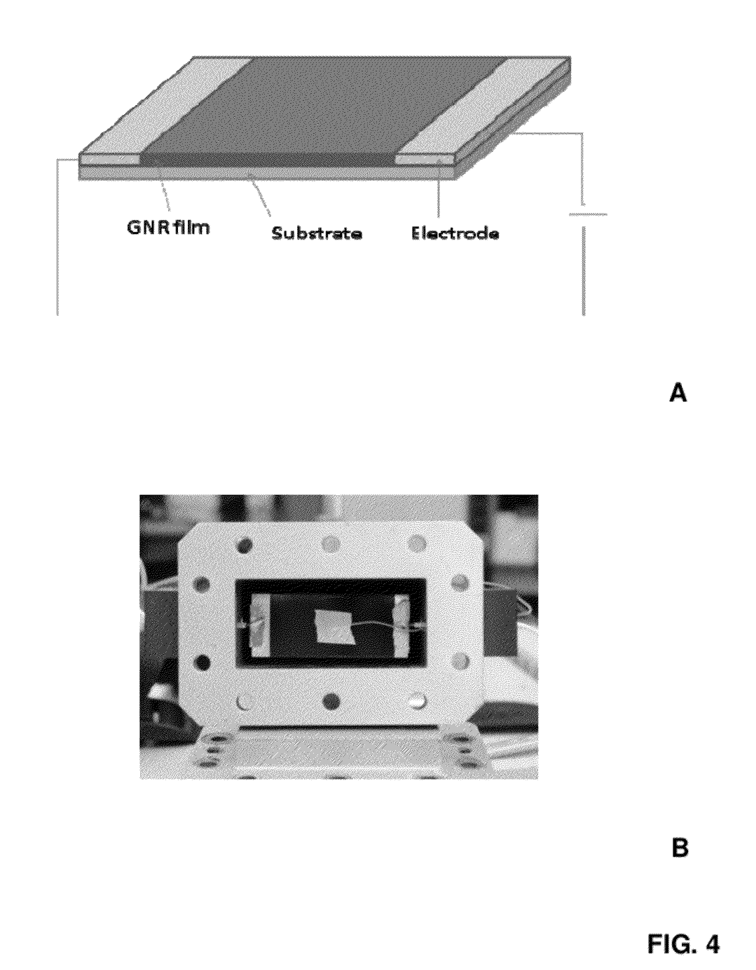

Another square sheet of a GNR film between copper electrodes is shown in FIG. 4A. In this example, the GNR film has a surface area of 1×1 meter square (˜40×40 inch=1600 square inches) and a thickness of 110 nm. This surface can be considered as a parallel connection of 40 strips of 1″×40″ films, or 20 sheets of 2″×2″ films connected in series. According to the data summarized in Table 1, the DC resistance of this graphene sheet is 2.51 kΩ*20/40=1.255 kΩ from end to end. Thus, if one applies 440 Vac 60 Hz (which is about 311 Volts rms) to the contacts at each side of this 1×1 meter square film, this power supply delivers the heat power of 77 W rms over the entire surface, or about 48 mW rms per square inch.

In order to melt ice on some surfaces at −25° C. and 75 knot winds, a heating power density of about 3 W per square inch may be needed. One way around this would be to use a higher voltage (e.g., sqrt(62)*440 Vac=3.5 kVac or 2.5 kV rms). Such high voltage power supply with transformer can deliver the heat power of 4.8 kW rms with about 2 amps rms current flowing. Such low current could be fed by a rather small gauge copper wire connected to the copper electrodes. In case this voltage is too high, or a de-icing surface is larger than 1×1 square meter, one can place additional electrodes on the graphene surface forming 3 to 4 rows connected in parallel, thereby reducing the applied voltages 3 to 4 times, and increasing the current flow in the same proportion.

### Example 4

### Waveguide Transmission Tests

Waveguide transmission tests were conducted in order to estimate the effective RF conductivity of GNR films. It is well known that various conductors (such as silver, gold, or cooper) have similar DC conductivities. Most of published work on graphene RF conductance has been focused on measurements of “few layers” of carbon atoms arranged in chicken wire patterns. According to the results shown in those studies, the effective RF conductance of few layered graphene slightly increases with frequency. For instance, at 4 GHz, the RF conductance of few layered graphene is about 1.5 times higher than DC conductance.

However, GNR films with thicknesses between 75 nm-100 nm do not represent “few layer” structures. Therefore, a similar S-matrix measurement waveguide technique was used to determine the effective RF conductance.

The waveguide test layout is shown in FIG. 3B. The wired graphene film with copper electrodes on polyimide substrate was put inside the waveguide, as shown in FIGS. 2 and 4B. The DC power supply (0-200 V) with voltage and current meter was connected to the film electrodes to measure DC resistance. The waveguide test data was compared with RF numerical simulation of the same structure using HFSS ANSIS tools.

The effective RF conductance is defined from results of HFSS simulation as the difference between measured and simulated transmission coefficient data over frequency. As shown in FIG. 3A, the frequency reaches the minimum of mean square error for GNR films with thicknesses of about 110 nm. Furthermore, according to Table 1, the DC effective conductance is 7.24 KS/m. According to the HFSS simulation, the RF effective conductance is 8 KS/m.

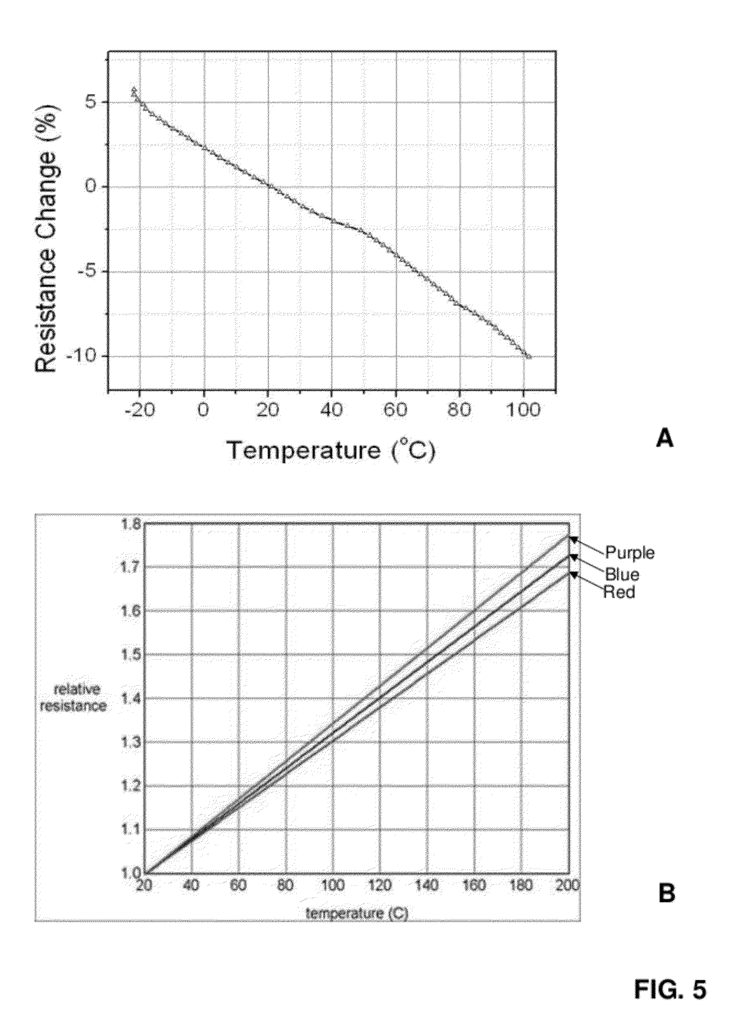

Another waveguide test setup is shown in FIG. 4. It was found during this test and separate tests that the graphene film has negative temperature coefficients of resistance (e.g., −10% from 20° C. to 100° C., as seen in FIG. 5A). In contrast, typical metals such as copper, aluminum, and silver have positive coefficients (e.g., +30% from 20° C. to 100° C., as seen in FIG. 5B). Negative temperature coefficients are useful because as the ambient temperature drops, the graphene film automatically delivers more heat power from the power supply of a stabilized voltage.

A two port network analyzer was calibrated without a graphene film inside a waveguide between 2.4 GHz (frequency slightly higher than the waveguide RG-48 cutoff frequency) and 3.8 GHz. This frequency range provides the measurement of complex transmission and reflection coefficients Sᵢⱼ of S-matrix:

$$S = [ \begin{matrix}{S}_{11} & {S}_{12} \\ {S}_{21} & {S}_{22}\end{matrix} ] . \qquad ( 5 )$$

Next, an additional test was carried out. The transmission coefficient of GNR layers was calculated as the difference between the transmission coefficient of graphene layer with electrodes, and the transmission coefficient of electrodes only. The results of these measurements are shown in FIG. 6. These results verified high RF tranperancy of GNR layers that were 110 nm in thickness (FIG. 6A) and 70 nm in thickness (FIG. 6B). The legend on the right shows the surface temperature of GNR layers during the test. Since the GNR layers have a negative temerature coefficient of resistance, the transmission coefficient slightly increases with temperature. But these variations are relatively small, especially for 75 nm thick films.

As expected, the transmission coefficient decreases as the layer temperature drops. Without being bound by theory, the data indicate that the RF conductance has the same negative temperature coefficient as the DC conductance. These data also confirm that GNR films are isotropic conductive materials.

### Example 5

### Numerical HFSS Simulation

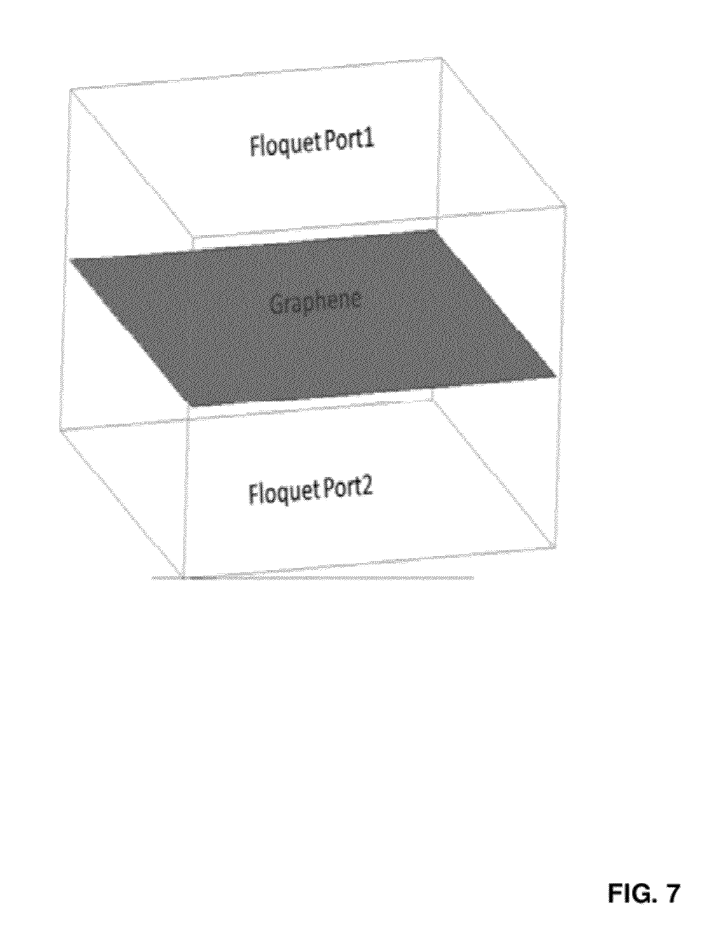

In this Example, graphene films were subject to high frequency structural simulator (HFSS) simulation. FIG. 7 illustrates the HFSS setup. FIGS. 8-11 summarize the results.

Specifically, FIG. 7 shows top and bottom faces of air boxes surrounding graphene layers. The top and bottom of air boxes are defined as Floquet ports that represent incident and reflected plane waves with different propagation direction as a function of azimuth (phi) and elevation (theta) angles. The matching periodical boundary conditions are assigned for side surfaces that extend the model periodically to infinity in both directions. The results of such HFSS simulations are valid if the graphene surface is much larger than the wavelength of incident plane wave. All results shown in FIGS. 8-11 are for graphene films containing graphene layers that are 110 nm in thickness. It is customary to consider two polarization cases of plane waves obliquely incident on planar surfaces: (1) plane waves with an electrical vector perpendicular to plane of incidence (i.e., TM00-mode); and (2) plane waves with electrical vector parallel to plane of incidence (i.e., TE00-mode). The plane of incidence is defined as a plane normal to the graphene layer that contains the direction of propagation of the incident wave.

The results of HFSS simulation for the reflection coefficient in TE00-mode are shown in FIG. 8. As expected, the reflection coefficient slightly depends on frequency. However, in the majority of cases, the reflection coefficient is low for any elevation angle up to theta=70 degrees.

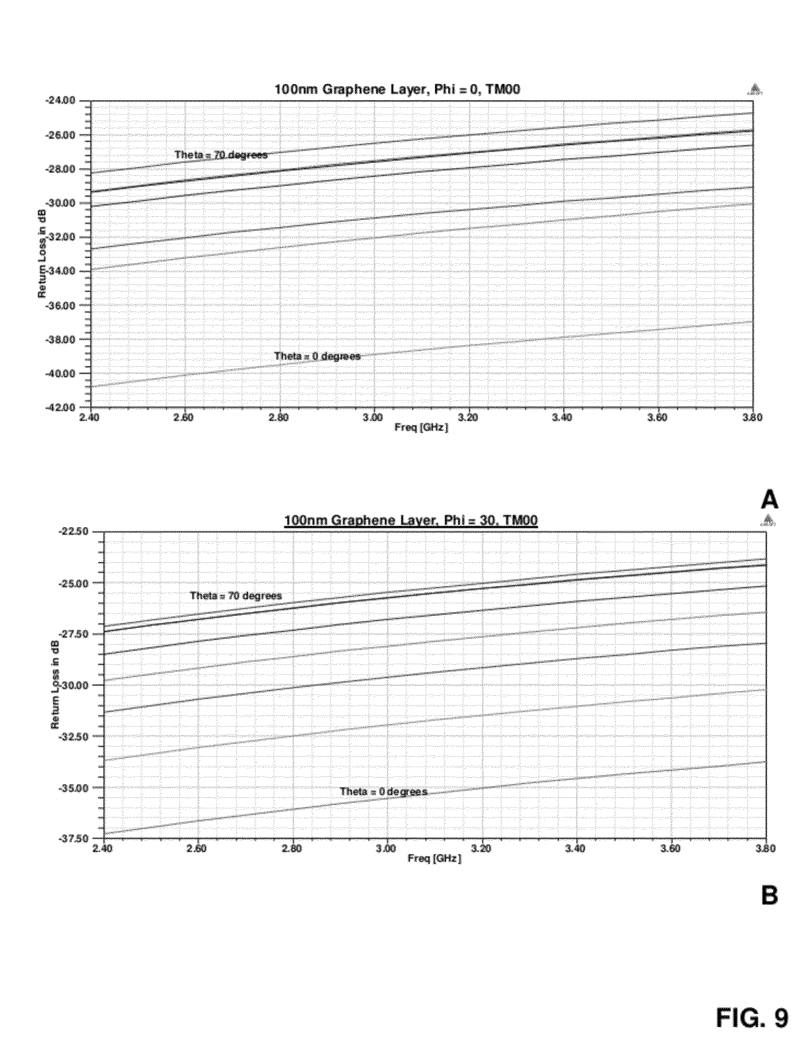

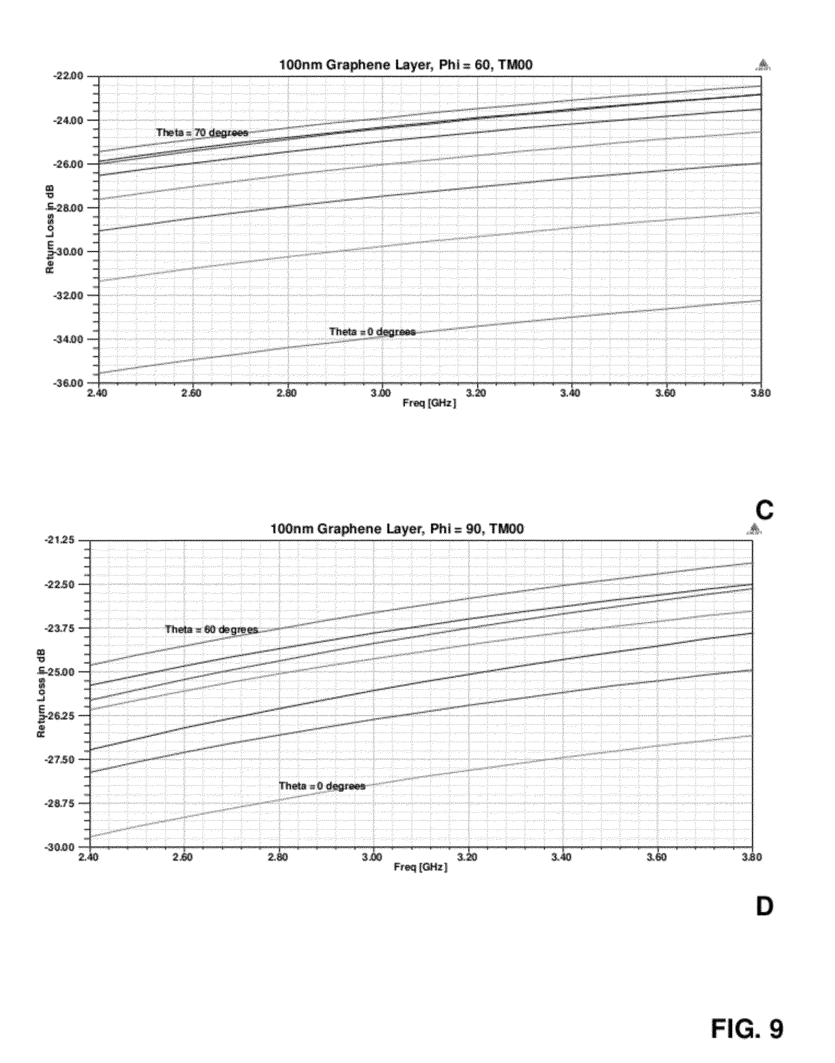

The results of HFSS simulation for the reflection coefficient in TM-00 mode are shown in FIG. 9. The electrical vector of TM-00 incident plane wave is parallel to the graphene surface for any angle of incident. Thus, the scattered back energy should be less than the energy scattered back in TE-00 mode. According to the results shown in FIG. 9, the reflection coefficient is below −25 dB to −28 dB.

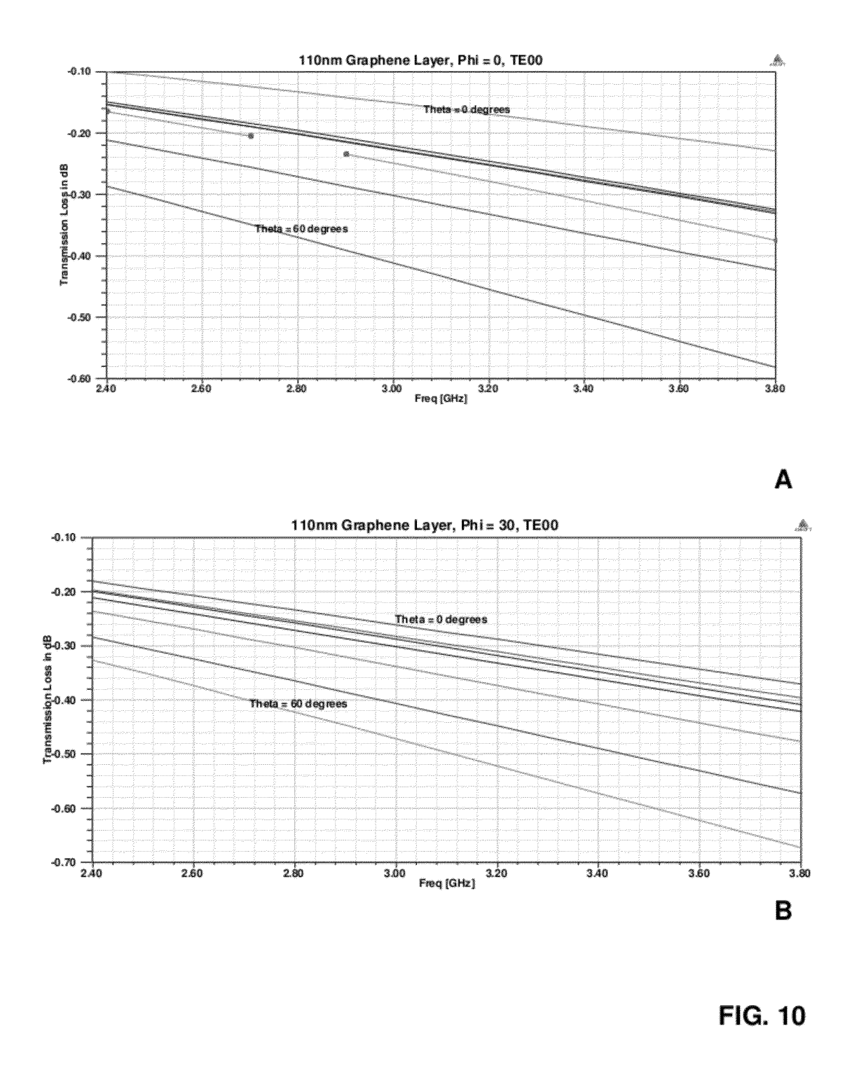

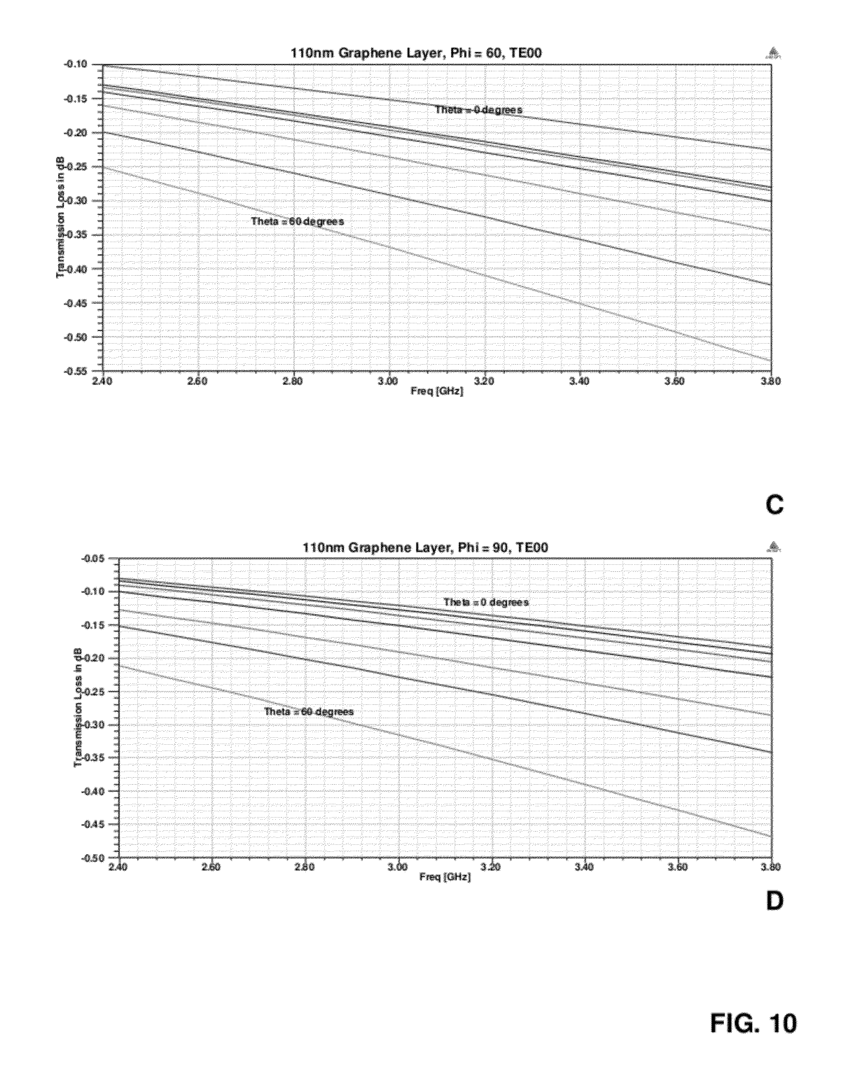

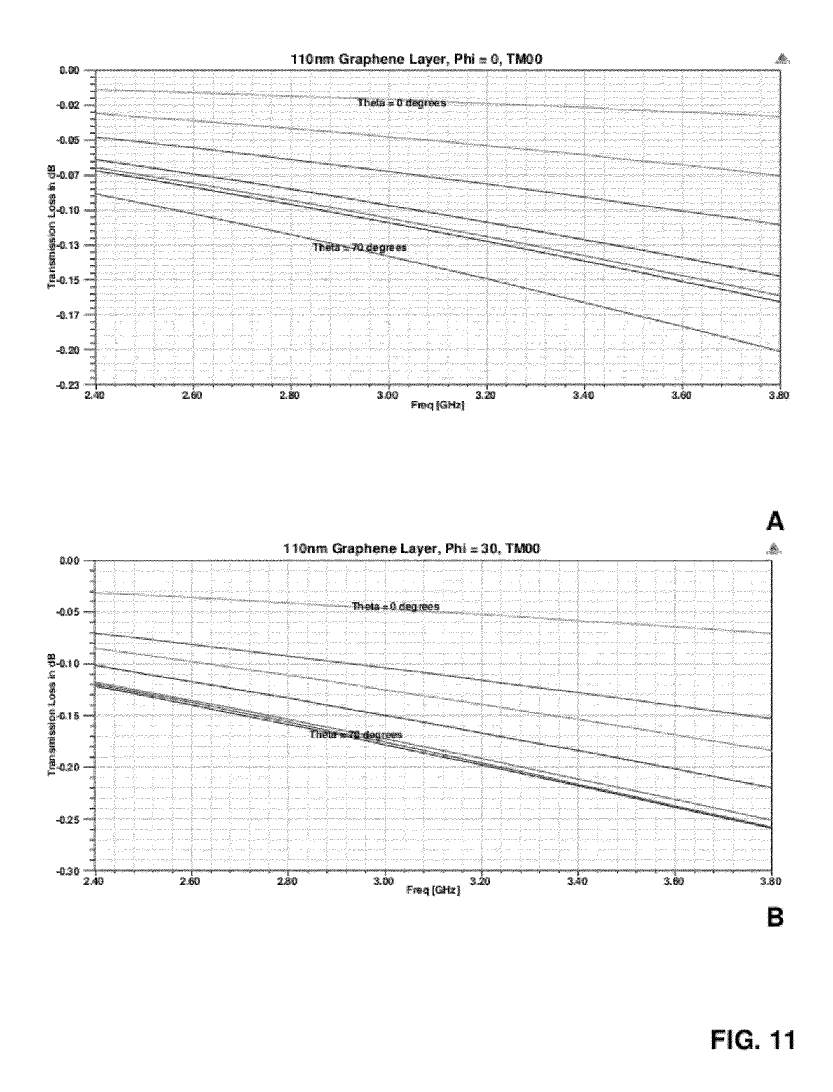

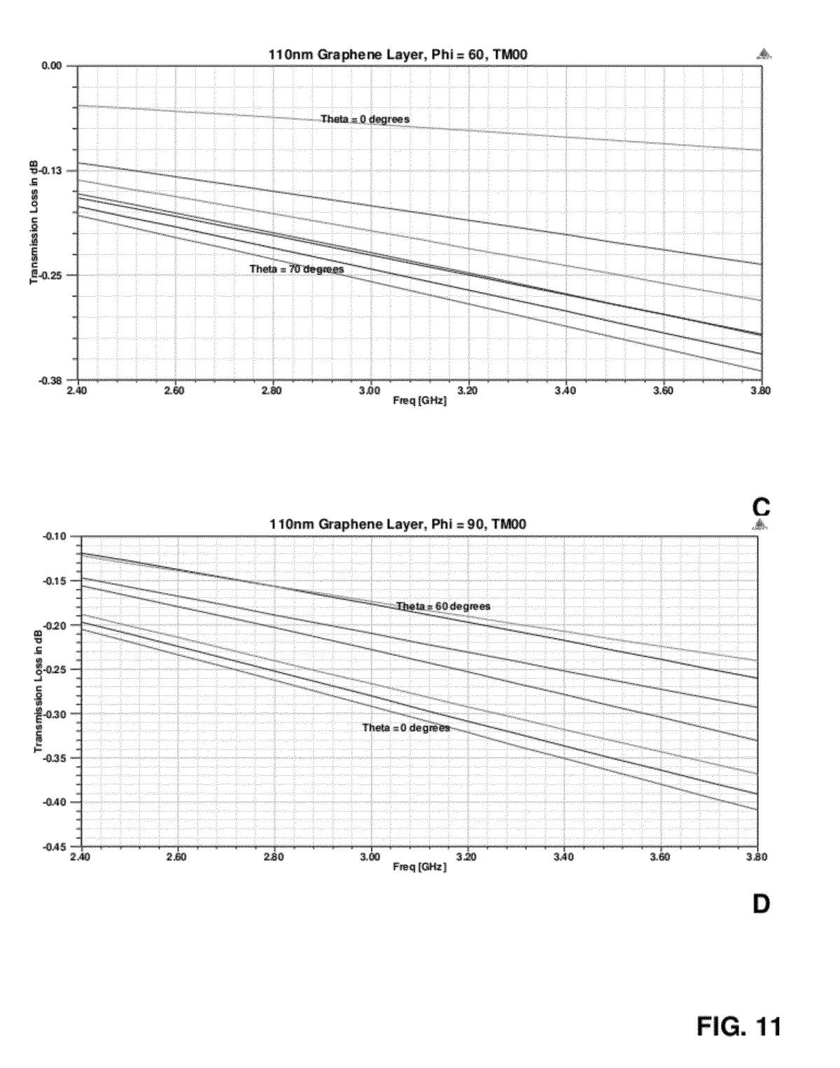

According to FIGS. 8-9, the scattering energy from the graphene layer is very low for any polarization of incident plane wave. Therefore, the graphene layer RF transmission loss (shown in FIGS. 10-11) is practically defined by the difference between the incident energy and energy passing through.

### CONCLUSION

In this work, the application of GNR films as heat circuits were evaluated. Based on the RF transmission tests and simulations, the electromagnetic wave loss did not exceed 0.3-0.4 dB. Furthermore, the transmission loss did not exceed 0.5-0.6 dB for any frequency below 4 GHz under any incident/scan angle. Applicants envision better results at any frequency below 2.4 GHz. Such results indicate that the sheet effective conductivities of GNR films are practically independent of frequencies of up to 4 GHz. Furthermore, since the thickness of GNR films are less than about 100 nm, the GNR films are practically transparent for RF signals up to 4 GHz. Moreover, it is expected that such RF transperacies can be extended to frequencies higher than 4 GHz with proper reduction in graphene layer thickness.

In addition, the GNR films become more RF transparent as the frequency decreases. According to waveguide test data, Applicants measured at 3 GHz a loss of 0.3 dB or 7% of incident power for GNR films with graphene layers that were 75 nm in thickness. Since classical RF conductivity is proportional to inverse function of skin depth at 1 GHz, Applicants can expect similar losses for graphene layers with similar thicknesses (e.g., 7*sqrt(1/3)=4% loss or 0.17 dB). Furthermore, since the graphene layer thickness is much smaller than the wavelength of incident electromagnetic waves (75 mm=75,000,000 nm at 4 GHz), the electromagnetic waves reflected from the front and back surfaces of graphene sheets have practically the same magnitude and opposite in phase. Thus, the reflection loss is low without any additional matching elements.

Without further elaboration, it is believed that one skilled in the art can, using the description herein, utilize the present invention to its fullest extent. The embodiments described herein are to be construed as illustrative and not as constraining the remainder of the disclosure in any way whatsoever. While the preferred embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A film comprising:
a graphene layer; and
a substrate associated with the graphene layer, wherein the film is electrically conductive and radio frequency (RF) transparent.

2. The film of claim 1, wherein the graphene layer is selected from the group consisting of functionalized graphene nanoribbons, pristine graphene nanoribbons, doped graphene nanoribbons, pristine graphene, doped graphene, graphene oxide, reduced graphene oxide, chemically converted graphene, split carbon nanotubes, mixtures of graphene nanoribbons and carbon nanotubes, and combinations thereof.

3. The film of claim 1, wherein the graphene layer is adhesively associated with the substrate.

4. The film of claim 1, wherein the graphene layer comprises graphene nanoribbons.

5. The film of claim 4, wherein the graphene nanoribbons are in contiguous sheets.

6. The film of claim 4, wherein the graphene nanoribbons are disordered on the substrate.

7. The film of claim 4, wherein the graphene nanoribbons are substantially aligned on the substrate.

8. The film of claim 4, wherein the graphene nanoribbons were derived from split multi-walled carbon nanotubes.

9. The film of claim 1, wherein the substrate is selected from the group consisting of glass, quartz, boron nitride, alumina, silicon, plastics, polymers, and combinations thereof.

10. The film of claim 1, wherein the substrate further comprises an adhesive layer, wherein the adhesive layer is positioned between the substrate and the graphene nanoribbon layer.

11. The film of claim 9, wherein the adhesive layer is selected from the group consisting of polyurethanes, epoxy resins, polyimides, nylons, polyesters, and combinations thereof.

12. The film of claim 1, wherein the graphene layer is positioned on a top surface of the substrate.

13. The film of claim 1, wherein the film has RF transparency between about 0.1 GHz and about 40 GHz.

14. The film of claim 1, wherein the film has RF transparency between about 0.1 GHz and about 18 GHz.

15. The film of claim 1, wherein the graphene layer has a thickness of between about 50 nm and about 100 nm.

16. A method of making an electrically conductive and radio frequency (RF) transparent film, wherein the method comprises:
associating a graphene composition with a substrate, wherein the associating forms a graphene layer on a surface of the substrate.

17. The method of claim 16, wherein the graphene composition is selected from the group consisting of functionalized graphene nanoribbons, pristine graphene nanoribbons, doped graphene nanoribbons, pristine graphene, doped graphene, graphene oxide, reduced graphene oxide, chemically converted graphene, split carbon nanotubes, mixtures of graphene nanoribbons and carbon nanotubes, and combinations thereof.

18. The method of claim 16, wherein the graphene layer comprises graphene nanoribbons.

19. The method of claim 18, wherein the graphene nanoribbons are in contiguous sheets.

20. The method of claim 18, wherein the graphene nanoribbons are disordered on the substrate.

21. The method of claim 18, wherein the graphene nanoribbons are substantially aligned on the substrate.

22. The method of claim 18, wherein the graphene nanoribbons were derived from split multi-walled carbon nanotubes.

23. The method of claim 16, wherein the substrate is coated with an adhesive layer.

24. The method of claim 23, wherein the adhesive layer is selected from the group consisting of polyurethanes, epoxy resins, polyimides, nylons, polyesters, and combinations thereof.

25. The method of claim 16, wherein the associating comprises a method selected from the group consisting of chemical vapor deposition, spraying, sputtering, spin coating, blade coating, rod coating, film coating, printing, painting, mechanical transfer, and combinations thereof.

26. The method of claim 16, wherein the associating comprises an annealing step, wherein the annealing step adhesively associates the graphene layer with the substrate.

27. The method of claim 26, wherein the annealing step comprises a heat treatment of the electrically conductive and transparent film.

28. The method of claim 16, wherein the film has RF transparency between about 0.1 GHz and about 40 GHz.

29. The method of claim 16, wherein the film has RF transparency between about 0.1 GHz and about 18 GHz.
